(19) United States
(12) Patent Application Publication
(10) Pub. No.: US 2006/0125257 A1
(43) Pub. Date: Jun. 15, 2006

(54) Pick and place tool for integrated circuit package

(75) Inventor: Fufeng Liang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/304,325

(22) Filed: Dec. 14, 2005

(30) Foreign Application Priority Data
Dec. 14, 2004 (CN) 200420054467.6

(51) Int. Cl. B25J 15/06

(52) U.S. Cl. 294/64.1

(57) ABSTRACT

A pick and place tool (10) includes a housing (11), a button (12), a linking pole (13) and a sealing stuff (14). The sealing stuff includes a fastening portion (141 held in the housing, and a sealing portion (142) extending from the fastening portion, wherein the sealing portion is deformable. The sealing portion forms a gas cavity (144). A head part of the linking pole is fixed with the button. A tail part (132) of the button has a same shape as the sealing portion of the sealing stuff. The button and the linking pole can remove relative to the housing together. In a free state, the tail part of the linking pole abuts against the sealing portion and separates the fastening portion and the sealing portion of the stuff. While operating an IC package with the pick and place tool, a user should place the sealing portion of the stuff on an upper surface (21) of an IC package (20), and should hustle the gas out of the gas cavity to reduce the air pressure. Accordingly, the IC package is adsorbed by the tool.

### BACKGROUND OF THE INVENTION

1. Field of the Invention

The invention relates to a pick and place toll for an integrated circuit (IC) package, especially to a tool using vacuum manner to operate an IC package.

2. Description of the Related Arts

As the computing technology is developing rapidly, the volume of an IC package is becoming smaller and smaller. An IC package is usually needed to be placed on a target component for achieving some specific function. A conventional method to deal with the procedure is to clamp edges of the IC package and then place the IC package on a target component. A clamping tool is accordingly required.

However, clamping the edges of the IC package will frat the edges, and will even break the IC package with improper force. While the clamping tool is used to operate an IC package with long pins, the clamping tool will damage the pins and will cause electricity failure.

In view of the above, what is needed is a new tool to pick and place an IC package conveniently and steadily.

### SUMMARY OF THE INVENTION

According to the present invention, a pick and place tool is provided to resolve the problems mentioned-above. The pick and place tool comprises a housing, a button, a linking pole and a sealing stuff. The sealing stuff includes a fastening portion held in the housing, and a sealing portion extending from the fastening portion, wherein the sealing portion is deformable. The sealing portion forms a gas cavity. A head part of the linking pole is fixed with the button. A tail part of the button has a same shape as the sealing portion of the sealing stuff. The button and the linking pole can remove relative to the housing together. In a free state, the tail part of the linking pole abuts against the sealing portion and separates the fastening portion and the sealing portion of the stuff. While operating an IC package with the pick and place tool, a user should place the sealing portion of the stuff on an upper surface of an IC package, and should hustle the gas out of the gas cavity to reduce the air pressure. Accordingly, the IC package is adsorbed by the tool. To release the IC package form the tool, the user should press the button for communicating the gas cavity and outer space to resume the air pressure. After that, the IC package will be divorced from the tool.

Other advantages and novel features of the present invention will become more apparent from the following detailed description when taken in conjunction with the accompanying drawings, in which:

### BRIEF DESCRIPTION OF THE DRAWINGS

FIG. 1 is an isometric view of a pick and place tool in accordance with a preferred embodiment of the present invention;

FIG. 2 is an exploded isometric view of the pick and place tool, a housing and a sealing stuff being partially cut out;

FIG. 3 is an assembled view of FIG. 2;

FIG. 4 is a cross-sectional view of the pick and place tool adsorbing an IC package; and

FIG. 5 is a cross-sectional view of the pick and place tool releasing the IC package.

### DESCRIPTION OF PREFERRED EMBODIMENT

Hereinafter, a preferred embodiment of the invention will be described in detail with reference to the attached drawings.

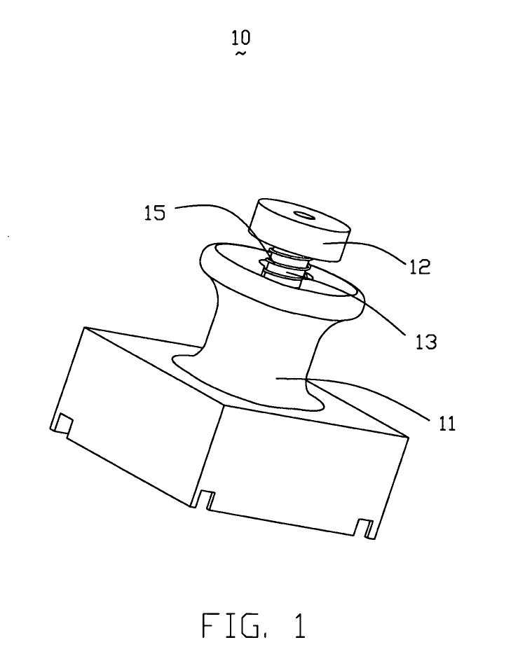

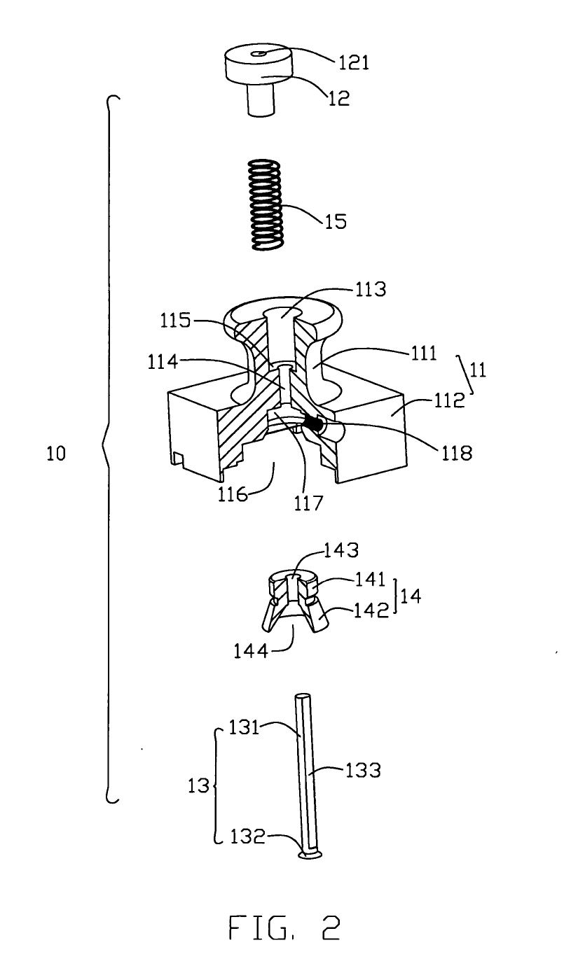

Referring to FIGS. 1-2, a pick and place tool 10 in accordance with a preferred embodiment of the present invention includes a housing 10, a button 12, a liking pole 13, a sealing stuff 14 and an elastic member 15. In the preferred embodiment, the elastic member 15 is a spring.

The housing 11 defines a threadlike neck portion 111, and a receiving body 112 extending downwardly from the neck portion 111. In this embodiment, the neck portion 111 is hollow cylindrical configured, and the receiving body 112 is hollow square configured. The neck portion 111 of the housing 11 defines a first channel 113 and a second channel 114, the first channel 113 being communicated with the second channel 114 and A diameter of the first channel 113 is greater than that of the second channel 114, and a step 115 is accordingly formed. The receiving body 112 of the housing defines a receiving room 116. A fastening hole 117 is defined in a top portion of the receiving body and is communicated with the second channel 114. Thus, the first channel 113, the second channel 114, and the fastening hole 117 of the receiving body 112 are communicated with each other. That is to say, the housing 11 is through-hole configured.

The button 12 defines a through hole 121. In this embodiment, the button 12 is columnar. In fact, the button can be designed as other configures.

The linking pole 13 defines a main body 131 and a tail portion 132 extending from the main body 131. The tail portion 132 is bowl-shaped. A part from a top end of the main body 131 to a portion adjacent to the tail portion 132 is cut away for forming a slit 133.

The sealing stuff 14 is made of elastic material and defines a fastening portion 141, and a sealing portion 142 extending from the fastening portion. The fastening portion 141 defines a guiding slot 143 therethrough. The sealing portion 142 is bowl-shaped and forms a gas cavity 144. The guiding slot 143 is communicated with the gas cavity 144. Therefore, the sealing stuff is perforative.

A maximum diameter of the main body 131 should be smaller than the diameter of the second channel 114, and an outer diameter of the tail portion 132 of the linking pole should be greater than that of the diameter of the second channel 114. In addition, the figure of the tail portion 132 inosculates with the figure of the sealing portion 142 of the sealing stuff 14.

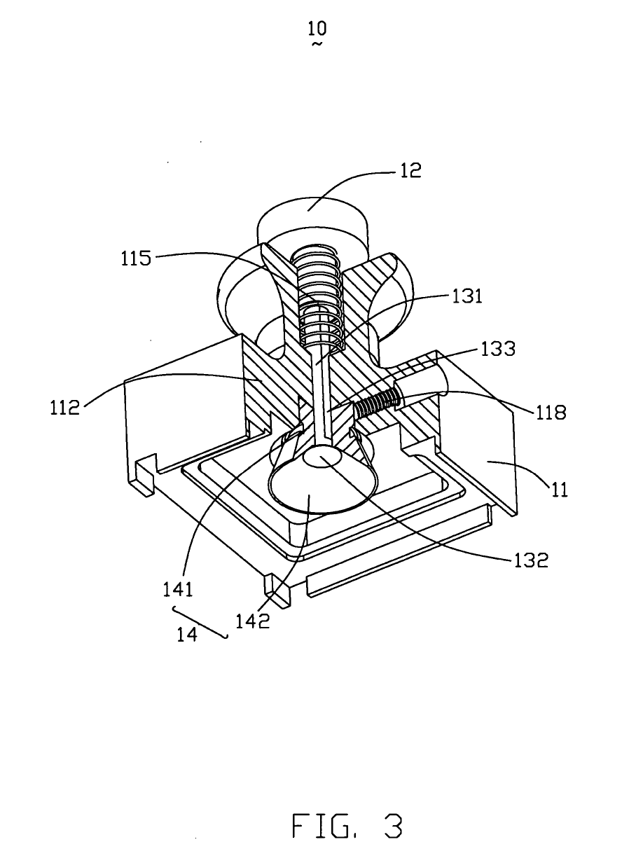

Referring to FIG. 3 together with FIG. 1, the assembly process of the tool 10 will be described in detail. The fastening portion 141 of the sealing stuff 14 is received in the fastening hole 117 of the receiving body 112, and the sealing stuff 14 engages with the housing 11. Engagement between the fastening portion 141 and the fastening hole 117 is achieved by virtue of interference. Other mode can be also applied to engage the fastening portion 141 and the fastening hole 117. For example, the housing 11 defines a whorl 118 corresponding to the position of the fastening hole 117 and a bolt (not shown) is used to cooperate with the whorl 118 for fastening the sealing stuff 14. The main body 131 of the linking pole 13 drills through the guiding slot 143 of the fastening portion 141, the second channel 114 and the first channel 113 in succession. The tail portion 132 finally abuts against the sealing portion 142 of the sealing stuff 14. By virtue of the slit 133, a clearance (not labeled) is accordingly formed between the main body 131 and the second channel 114. After the linking pole 13 is assembled with the housing 11 and the sealing stuff 14, the spring member 15 enwraps the main body 131 of the linking pole 13, and one end of the spring member 15 is stopped by the step 115. Finally, a head portion of the linking pole 13 is received in the through hole 121 of the button 12. The spring member 15 is located between the button 12 and the step 115 and is pressed therebetween.

In a free state (no exterior force applied), the tail portion 132 abuts against the bowl-shaped sealing portion 142, and gas cavity 144 is separated from the fastening hole 117, the second channel 114, the first channel 113, and the through hole 121. At the same time, the second channel 114, the first channel 113, the guiding slot 143 and the through hole 121 are communicated with each other.

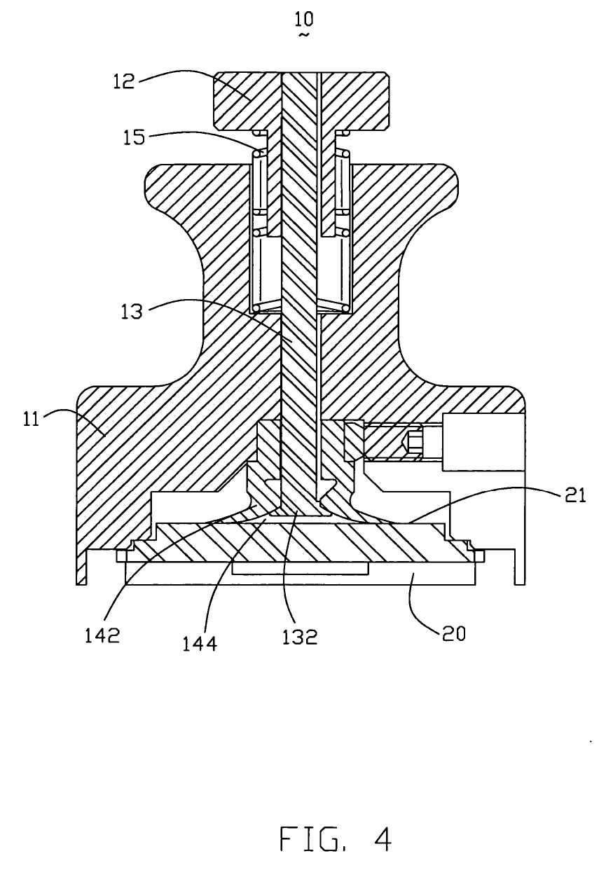

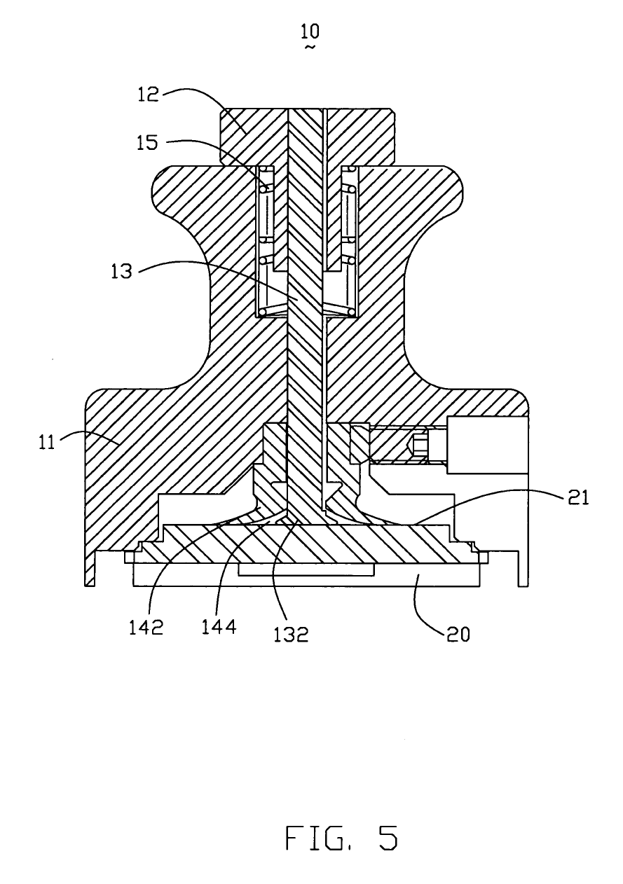

Referring to FIG. 4, how to use the pick and place tool 10 is described in detail. First, a user should press the sealing stuff 14 compactly on an upper surface 21 of an IC package 20 to hustle the gas out of the gas cavity 144 for reducing the air pressure therein. The IC package 20 is thus adsorbed by the tool 10. After that, the IC package 20 can be transmitted to a predetermined position. Referring to FIG. 5, the user should press the button 12 for release the IC package 20. While the user presses the button 12, the linking pole 13 moves toward the gas cavity 144. When the slit 133 enters the gas cavity 144, the gas cavity 114 is communicated with the outer space via the fastening hole 117, the second channel 114, the first channel 113 and the through hole 121. Therefore, the air pressure of the gas cavity 144 resumes to the same level as the outer space. Adsorption between the upper surface 21 of the IC package 20 and the sealing stuff 14 is accordingly removed. And the IC package 20 is divorced from the tool 10 by virtue of the gravity thereof. In the preferred embodiment, a slit 133 is defined for forming a clearance. In fact, the clearance can be also formed by reducing the diameter of the main body 131 of the linking pole 13.

Furthermore, although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A pick and place tool for an integrated circuit package, comprising:
a perforative housing;
a perforative button;
a linking pole defining a main body engaged with the button and a tail portion extending from the main body, the linking pole together with the button being removable relative to the housing;
a sealing stuff, defining a fastening portion positioned in the housing, and a deformable sealing portion extending from the fastening portion, a gas cavity being defined on the sealing portion; wherein
a clearance is formed between the linking pole and the housing, the button, and the sealing stuff; and
in a free state, the tail portion abuts against the sealing portion for separating the gas cavity from the clearance; and movement of the linking pole enables communication between the clearance and the gas cavity.

2. The pick and place tool as described in claim 1, wherein the housing defines a neck portion and a receiving body extending from the neck portion.

3. The pick and place tool as described in claim 2, wherein the neck portion defines a first channel and a second channel, and the receiving body defines a fastening hole communicating with the second channel for receiving the fastening portion of the sealing stuff.

4. The pick and place tool as described in claim 3, wherein a diameter of the first channel is greater than that of the second channel for forming a step.

5. The pick and place tool as described in claim 3, wherein a spring member is pressed and located between the step and the button.

6. The pick and place tool as described in claim 1, wherein the main body of the linking pole defines a slit for forming a clearance between the main body and the housing, the button and the sealing stuff.

7. The pick and place tool as described in claim 3, wherein a diameter of the main body of the linking pole is smaller than those of the first channel and the second channel.

8. A pick and place tool comprising:
a housing defining a downward receiving cavity dimensioned to comply with an IC package periphery for receiving said IC package therein;
a sealing stuff disposed in the housing, said sealing stuff defining a deformable sealing portion downward facing to said receiving cavity; and
a pole associated with the housing and moveable relative to the housing; wherein the sealing stuff is adapted to pick up the IC package by deformation of the sealing portion under a negative air pressure, and later to place said IC package into a socket by ejection of said IC package via a movement of said pole which breaks said negative air pressure and make said IC package released from the sealing portion and allow the IC package to downward move and be place in a position.

9. The pick and place tool as claimed in claim 8, wherein the pole is moveable relative to the housing vertically.

10. The pick and place tool as claimed in claim 8, wherein a tail portion of said pole, which is used to break said negative air pressure, is normally located above the sealing plane of said sealing portion, which is used to suck the IC package, for allowing the sealing portion effectively sucks the IC package.

11. The pick and place tool as claimed in claim 10, wherein said tail portion is also adapted to be moved below said sealing plane for abutting against the IC package thereunder.

12. The pick and place tool as claimed in claim 10, further comprising a resilient device to urge said pole upwardly so as to keep said tail portion located above said sealing plane normally.

13. The pick and place tool as claimed in claim 8, wherein said negative air pressure is formed in a gas cavity which is formed by said sealing portion.

14. The pick and place tool as claimed in claim 10, wherein said negative air pressure is formed in a gas cavity which is formed by said sealing portion and said tail portion.

15. The pick and place tool as claimed in claim 8, wherein said pole extends through said sealing stuff vertically.

16. A pick and place tool comprising:
a housing defining a downward receiving cavity dimensioned to comply with an IC package periphery for receiving said IC package therein;
a sealing stuff disposed in the housing, said sealing stuff defining a deformable sealing portion downward facing to said receiving cavity, said sealing portion defining a sealing plane; and
a pole associated with the housing and moveable relative to the housing; wherein the sealing stuff is adapted to pick up the IC package by deformation of the sealing portion under a negative air pressure, and later to place said IC package into a socket by ejection of said IC package via a movement of said pole which has a tail portion extends beyond the sealing plane to have said IC package released from the sealing portion and allow the IC package to downward move and be place in a position.

17. The pick and place tool as claimed in claim 16, further comprising a resilient device to urge said pole upwardly so as to keep said tail portion located above said sealing plane normally.
